(19) United States
(12) Patent Application Publication
(10) Pub. No.: US 2019/0183093 A1
(43) Pub. Date: Jun. 20, 2019

(54) TRAINING DEVICE FOR ANIMALS

(71) Applicant: Oleksandr Skoropys, Chernihiv (UA)

(72) Inventor: Oleksandr Skoropys, Chernihiv (UA)

(21) Appl. No.: 15/844,578

(22) Filed: Dec. 17, 2017

(51) Int. Cl. A01K 15/02

(52) U.S. Cl. CPC A01K 15/025; B32B 25/10

(57) ABSTRACT

A dog training device is used for the training and education of animals or playing with animals, and can be used for game, recreational or rehabilitation exercises with a dog as well as for therapeutic exercises and prevention of the lack of dog's physical and psych emotional activities. The dog training device includes a ring-shaped body made of a foamed cross-linked compound (the compound) including an ethylene vinyl acetate. The compound also includes a rubber in the amount required to achieve hardness of the compound wherein the hardness based on the Shore A Scale is in the range of 55 to 65 and density of the compound is in the range of 0.2 to 0.3 g/cm3 and tensile strength of the compound is in the range of 6 to 9 MPa, and ultimate elongation of the compound is in the range of 105 to 150%, with the compound also including a non-abrasive filler with particle size ranging between 2 and 5 microns.

### FIELD OF THE INVENTION

The invention relates generally to devices for training and education of animals or playing with animals, preferably dogs, and can be used for game, recreational or rehabilitation exercises with a dog as well as for therapeutic exercises and prevention of the lack of dog's physical and psych emotional activities, and more particularly to training device used for training of the dogs recovering from injuries of the locomotor system to provide faster recovery.

### BACKGROUND OF THE INVENTION

The art of animal training devices is replete with various training solutions based on the use of a polymer compound in the composition of training devices or toys, preferably for dogs, which, due to certain physical parameters, provide certain benefits during training or playing, including in particular improved safety for a dog and/or a human, reliability and ease of use and substantially increased service life of the article along with increased safety for a dog when dog's teeth come in contact with the article, for example, when a dog bites down on it, that is common for the most dog training exercises, are known to the applicant.

One of such prior art devices used for training of animals or playing with animals is disclosed in International application number WO2012/166078A1. This device for the training of animals or playing with animals includes a body in the form of torus made of ethylene vinyl acetate. The body of the device may consist of two separate identical parts, each in the form of torus made of ethylene vinyl acetate (EVA). The body may also comprise a holding means for a human, the means being configured in the form of letters and/or numbers and/or characters of the alphabet and/or geometric shapes. Such means can be convex on the outer surface of each part of the body. However, the International application number WO2012/166078A1 fails to disclose certain mechanical parameters of the material of the body (EVA), that helps to obtain additional benefits of the dog training or achieve improved reliability and service life of the training device.

Another prior art reference, namely U.S. Pat. No. 5,485,809 discloses a chewable animal toy including principally an ethylene/methacrylic acid copolymer, ionically cross-linked ionomer resin. The metal component in this polymer is sodium. The hardness of the toy is 65-99 with a preferred range of 75-85. A flavoring additive is dispersed throughout the body of the animal toy. In the process of making the animal toy, the flavoring additive is dry mixed with pellets of the ionomer resin before melting and die injection molding the toy. The product is an ingestion safe toy that resists puncturing, cracking, splintering, or shattering, and has a roughening finish which is desirable for the satisfaction and hygiene of the animal. The advantage of this technical solution is that it is desirable for animals, due to flavoring additives contained in the material and due to the texture of the surface. Further, the toy has increased durability and safety for an animal due to the composition of the material and the method of making the same. However, the body of the toy does not have sufficient physical parameters, such as copolymer density, elongation to break and durability, making it unsuitable for training of dogs, in particular, in the exercises such as running, stretching etc.

Alluding to the above, the material of the body, along with its shape, does not help to improve the safety and convenience of dog training exercises, in particular the dog's skull and gums may be damaged when the dog bites down on and pulls the body or the material of the body may be destructed and the article breaks down quickly. Further, the composition of the material of the body does not allow for a weight reduction and buoyancy of the toy, so this imposes additional constraints on the convenience of training and use of the toy. Moreover, the attractiveness of the toy for an animal is achieved only by the presence of flavoring additives, which vary for different animals, and this prevents making a more versatile article to be used for different animals.

Another prior art reference, such as U.S. Pat. No. 6,576,246, discloses a chewable, biodegradable article for the use as a pet toy comprising a matrix made of a natural polymer, a synthetic organic polymer or a mixture thereof, a natural or synthetic fibrous material that comprises fibers and that is bonded chemically or physically with the matrix material, and, optionally, includes one or more microbe inhibiting agents that inhibit the growth of microbes in or on the article, is known in the art. The presence of the fibrous material inhibits formation of sharp edges upon breakage, for example, when the article is gripped by teeth, chewed, or torn etc. thereby rendering the article safer when used by pets. However, the drawback of this article is that it lacks attractiveness for a dog when the dog bites down on it as the attractiveness can be achieved by certain physical parameters of the matrix material or fibers. Further, the article is not sufficiently lightweight and reliable given the composition of its material, which, along with the lack of optimal shape of the article, reduces the convenience of the use during the training and the service life, especially during the training of large dogs which will destroy the article quite quickly.

A ductile pet chew having oral care preparations is known in the art and is disclosed in U.S. Pat. No. 6,672,252. To achieve the above properties, the ductile pet chew comprises: an amount of a ductile polymeric material so that said chew has a tensile strength ranging between 200 psi and 1,050 psi, flexural strength ranging between 3 lbs. and 75 lbs., shear strength ranging between 80 lbs. and 175 lbs., hardness between 68 and 90, and penetration between 2 and 28 percent. Further, the article comprises inclusions, which are selected from the group consisting of a fiber component, a hard component, and mixtures thereof. The said polymeric material is equal to between 70% and 90% by weight of the pet chew and is selected from the group consisting of protein based polymers, starch based polymers, synthetic polymers, and combinations thereof, and is preferably a synthetic polymer. The said fiber components have a length of greater than 900 μm and are selected from the group consisting of synthetic fibers, cellulose, sisal, cotton, and combinations thereof. The hard component is added in an amount ranging between 5% and 45% by weight of said polymeric material and is selected from the group consisting of whole grains, ground grains, processed grains, legumes, minerals, and combinations thereof. The said article provides the safety when animal's teeth come in contact with it and penetrate into or rub against the polymer or when a dog bites or chews it and provide an effect of treatment if fibrous components and solid elements are present in the article. In this case, the fibrous components provide and increase the durability of the article when a dog bites down on and chews it. The attractiveness for an animal is achieved by the use of materials based on organic matters, in particular solid components or polymer materials.

However, the said article does not provide the convenience of dog training due to the lack of a certain form, given that it is important to provide not only certain physical parameters of the material or the use of fillers, but also a certain shape of the article for such training. Further, this article is intended primarily for playing safe games and, at the same time, treatment of animal's teeth and gums and was not designed to reduce the weight of the article, increase convenience of dog training exercises and expanding the range of exercises using the same article.

The increased reliability of the training device along with the safety and attractiveness for biting by a dog is achieved in an animal chew for chewing by an animal comprising: a body portion including an outer layer having a first hardness, said body portion having a first and second end sections with an edge thereof; and an end piece having a hardness that is greater than the hardness of the body portion, the end piece configured to engage with said body portion. The outer layer is made of an elastomer. The end piece is configured to protect said edge sections from contact with animal's jaws during said chewing, biting etc. In other words, the said article is safe mainly for a human. However, the said article has a rather complicated and not sufficiently reliable design due to the presence of end pieces having other hardness of the material and their specific shape, and does not allow to diversify dog training exercises, which is necessary for dog's normal development, in particular, as stated above. Further, the article does not provide for better attractiveness for dogs.

An animal chew toy is also known in the art and disclosed in US Application Publication No. 2006/0201446. The toy comprises a body made of elastomeric material having a density of less than 0.95 g/cm3 and a tensile strength of at least 2.0 MPa. The material has a minimum elongation in the range of 200%-600% and a material comprising pores, in particular closed pores, and has a pore density of 20-48 pores/cm3 an average pore diameter of 25-200 microns. The porous material comprises microcellular polyurethane that has a flavor desirable to a dog. The shape of the body is preferably a figure of rotation having compound cross-section, formed by several interconnected ring surfaces of different diameters. The described toy has a lightweight, floating body, which, at the same time, provides increased durability when it is chewed and broken with teeth and is more desirable to dogs as a toy.

However, the disadvantage of this toy is its limited use as a training device, due to the shape of the body, which is not sufficiently suitable for holding by hand and capturing by dog's jaws. Further, the said material does not allow for increased safety for dog's jaws when a dog bites down on the body. The material of the body is not desirable to a dog especially when the dog bites down on the body due to the sense of the body with dog's teeth which also restricts the use of the toy as training devices for exercises with the dog.

Another prior art toy for animals containing a body consisting of a hollow core made of one polymer material (thermoplastic material) and a coating made of another thermosetting polymer material. The polymeric material of the hollow core has a higher hardness than that of the coating and is bonded to it through a thermal-chemical reaction. In particular, ethylene-propylene rubber (EPDM), which has a hardness of 20-80 by on the Shore A Scale, is used as a thermosetting polymer material. In this case, the polymeric material of the hollow core has a tensile strength of at least 1500 N/m2 and a hardness of at least 50 units on the Shore A Scale. The body may have a bone shape that consists of a central cylindrical piece connected to end pieces having a larger diameter than the central portion or a spherical shape. An electronic device for acoustic, olfactory or visual effects attracting a dog may be placed inside the case.

The drawback of such toy is a relatively complex shape of the body, which still does not allow the performance of some dog training exercises, such as running or water exercises, and does not sufficiently enhance the safety of using the toy for a human training a dog because human's hand may slip off the toy body. Further, the material of the toy does not make it desirable for a dog to bite it, i.e. use receptors on its jaws, which is important for training of most dogs.

Still another prior art reference is disclosed in US Application Publication No. 2009/0314222. An improved pet toy that has a toy body composed of polyolefin having appropriate flexibility and resiliency, in particular an ethylene vinyl acetate (EVA) copolymer is considered the closest prior art. The body may be configured to have any geometric shape, in particular, a ring shape. The attractiveness for biting by an animal is achieved by the presence of interconnected chambers inside the body, in which movable elements are placed so that when an animal bites down the chambers, air pressure is altered within the chambers, and movable elements are moved creating sounds that can be heard by the animals.

Due to the use of the body in the form of a ring made of ethylene vinyl acetate, the said training device has a relatively small weight that improves the convenience of using it in most dog training exercises, such as running, stretching, jumping, etc., and extending the range of such exercises. Nevertheless, the design, in particular, the presence of chambers with moveable elements, the sound of which attracts the animal, but does not allow to provide the necessary strength of the toy during the training of dogs, especially those with heavy weight.

Further, the said design, on the contrary, makes the use of the dog training toy dangerous because when a dog bites down on or comes in contact with movable elements in the chambers, the dog's jaws and/or gums may be damaged. At the same time, such is not attractive for biting by animals (a very important feature for dogs that often prevails any exercises and is an integral element of any training), and which can only be achieved by the composition of the material which the dog will like to bite. Further, the description of the toy does not contain data on the physical parameters of the material—ethylene vinyl acetate, which is known for its small weight but has certain limitations in terms of strength, ultimate elongation and tensile strength.

These prior art devices have numerous drawbacks and limitations. Accordingly, there remains a need for an improved devices for training and education of animals or playing with animals, preferably dogs, and can be used for game, recreational or rehabilitation exercises with a dog as well as for therapeutic exercises and prevention of the lack of dog's physical and psych emotional activities, and more particularly to training device used for training of the dogs recovering from injuries of the locomotor system to provide faster recovery that will eliminate the aforementioned drawbacks associated with the prior art devices.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a perspective view of a half portion of a device of the present invention;

FIG. 2 illustrates a side view of the device;

FIG. 3 illustrates a side view of the half portion of the device;

FIG. 4 illustrates a schematic view of the material that the devices is comprised of wherein each material is shown in its percentage portion; and

FIG. 5 illustrates a top view of the device.

### SUMMARY OF THE INVENTION

A dog training device is used for the training and education of animals or playing with animals, and can be used for game, recreational or rehabilitation exercises with a dog as well as for therapeutic exercises and prevention of the lack of dog's physical and psych emotional activities. The training device should be used for training of the dogs recovering from injuries of the locomotor system to provide faster recovery of their working capacity and development of motor qualities.

The dog training device includes a ring-shaped body made of a foamed cross-linked compound (the compound) including an ethylene vinyl acetate. The compound also includes a rubber in the amount required to achieve hardness of the compound wherein the hardness based on the Shore A Scale is in the range of 55 to 65 and density of the compound is in the range of 0.2 to 0.3 g/cm3 and tensile strength of the compound is in the range of 6 to 9 MPa, and ultimate elongation of the compound is in the range of 105 to 150%, with the compound also including a non-abrasive filler with particle size ranging between 2 and 5 microns.

The object of the invention is to increase the reliability, duration, convenience and safety of the use of the training device for performing exercises with a dog for both the dog and the human, while making the training device more desirable for biting by a dog and improving the stability of the body to cracking, as well as to significantly simplify the making of the training device, which should be achieved by combining the shape and the material of the body of the training device, in contrast to the complication of the structure of the body or the use of a combination of different physical parameters of the materials known in the art.

In the testing of the said training device, it has been found that the provision of certain mechanical parameters of the material of the body—ethylene vinyl acetate—helps to obtain additional benefits of the dog training or achieve improved reliability and service life of the training device. The required mechanical parameters of the material can be achieved by the appropriate ratio of the components of ethylene vinyl acetate, the addition of components to the general composition of the polymer and by performing the polymerization process under certain parameters.

According to one embodiment of this invention, the compound may comprise the said components in the following ratio, % wt.: Rubber from 20 to 50, Non-abrasive filler from 10 to 30, and Ethylene vinyl acetate to cover the rest.

According to a more specific embodiment of this invention, the compound may comprise the said components in the following ratio, % wt.: Rubber 30, Non-abrasive filler 20, and Ethylene vinyl acetate to cover the rest the rest.

The object of the present invention is also achieved so that in the known dog training device made in the form of a preferably ring-shaped body made of a foamed cross-linked compound comprising ethylene vinyl acetate, according to another embodiment of the invention, the compound further comprises rubber in the amount required to achieve the compound's hardness on the Shore A Scale in the range of from 55 to 65, density in the range of from 0.2 to 0.3 g/cm3, tensile strength in the range of from 6 to 9 MPa and ultimate elongation in the range of from 105 to 150%, and comprises a non-abrasive filler with particle size ranging between 2 and 5 microns and comprises an odor absorber and/or deodorant.

According to another embodiment of this invention, the compound comprises the said components in the following ratio, % wt.: Rubber from 20 to 50, Non-abrasive filler from 10 to 30, Odor absorber and/or deodorant from 2 to 5, and Ethylene vinyl acetate to cover the rest.

According to a more specific embodiment of this invention, the compound comprises the said components in the following ratio, % wt.: Rubber 30, Non-abrasive filler 20, Odor absorber and/or deodorant 3, and Ethylene vinyl acetate to cover the rest.

According to one embodiment of the both inventions, a natural filler is selected from the group consisting of: calcite or talc or sodium zeolite A or chemically precipitated chalk may be used as a non-abrasive filler.

According to one of the embodiments of the both inventions, the body preferably has bending resistance ranging between 30,000 and 50,000 bends.

The said features of the invention according to both embodiments allow achieving the technical result determined by the inventor. Thus, it is obvious that the material of the body should have hardness within certain limits, which provides, on the one hand, the necessary strength of the body when it is torn by a dog during exercises and, on the other hand, does not damage dog's teeth (cuspidate teeth, premolars, molars) when a dog bites down on the body.

The composition of the compound determined through experiments allows to obtain the abrasive qualities of the material of the body of the training device which ensure the painless entry of the dog's cuspidate tooth into the body when a dog bites down on the device (effect of amortization), that is common for the most dog training exercises. In this case, such composition provides bending resistance ranging between 30,000 and 50,000 bends that increases the reliability of the body during dog training exercises.

By testing the training device so created, the inventor determined that if the body material has hardness on the Shore A Scale of less than 55 and density of less than 0.2 g/cm3, dog's jaws can squeeze the body of the training device very much and damage the human hand. On the other hand, if the material of the body has hardness on the Shore A Scale of more than 65 and density of more than 0.3 g/cm3, dog's teeth can be damaged and, consequently, the training device will be less desirable for a dog to grip it next time. Further, the embodiment of the body so that hardness on the Shore A Scale is more than 65 and density is more than 0.3 g/cm3 makes the material of the body high dense which accelerates the wearing down of dog's teeth when the training device is used. In other words, high density and hardness provide such abrasiveness of the material so that dog's teeth are surrounded tightly when a dog bites down on the article and does not allow the dog to pull the teeth out of it freely.

Further it was noted that the compound with tensile strength in the range of from 6 to 9 MPa and ultimate elongation in the range of from 105 to 150% provide an additional increase in the strength of the material of the training device when it is torn by a dog, which is accompanied by a variable load on the material, that is, bending and stretching, under which the body of the training device does not break, but ‘flows’, which prevents its premature destruction.

The inventor has determined through numerous experiments that the above-mentioned qualities of the material can be achieved by adding a certain amount of rubber and a non-abrasive filler with certain physical and mechanical properties to the compound. For this purpose, the inventor conducted a series of studies with different contents of rubber and a non-abrasive filler, the results of which are shown in Table 1 and Table 2.

TABLE 1
Dependence of physical and mechanical properties of
the material of the body (Hardness of the compound
on the Shore A Scale, units, and ultimate elongation
of the compound, %) on the content of rubber

| | | Hardness of the | Ultimate |
|---|---|---|---|
| Content of | Content of | compound on the | elongation |
| rubber, | non-abrasive | Shore A Scale, | of the com- |
| % wt. | filler, % wt. | units | pound, % |
| 10 | 10-30 | 72 | 100 |
| 20 | | 65 | 105 |
| 30 | | 60 | 112 |
| 40 | | 57 | 124 |
| 50 | | 55 | 150 |
| 60 | | 52 | 230 |

TABLE 2
Dependence of physical and mechanical properties of the
material of the body (Hardness of the compound on the
Shore A Scale, units, and ultimate elongation of the
compound, %) on the content of a non-abrasive filler

| | | Hardness of | Tensile | Ultimate |
|---|---|---|---|---|
| Content of | Content of | the compound | strength | elongation |
| rubber, | non-abrasive | on the Shore | of the com- | of the com- |
| % wt. | filler, % wt. | A Scale, units | pound, MPa | pound, % |
| 20-50 | 5 | 49 | 15 | 180 |
| | 10 | 55 | 9 | 150 |
| | 20 | 61 | 7 | 118 |
| | 30 | 65 | 6 | 105 |
| | 40 | 68 | 5 | 98 |

According to the results presented in Table 1 and Table 2, the material comprising rubber in the range of from 20 to 50% wt. and a non-abrasive filler in the range of from 10 to 30% wt. provides the required physical and mechanical parameters of the material as described above and necessary for obtaining a definite technical result.

Further, the inventor completed a series of studies with a non-abrasive filler having various physical and mechanical parameters, the results of which are presented in Table 3.

TABLE 3
Dependence of physical and mechanical parameters of the material
of body on a particle size of a non-abrasive filler

| Particle size of non-abrasive | Tensile strength of the |
|---|---|
| filler, micron | compound, MPa |
| 1 | 11 |
| 2 | 9 |
| 3 | 7.5 |
| 4 | 6.5 |
| 5 | 6 |
| 10 | 5 |
| 20 | 4 |

According to the results presented in Table 3, the use of a non-abrasive filler in the said % wt. with a particle size ranging between 2 and 5 microns is required to achieve the physical and mechanical parameters of the material described above and required for obtaining some definite technical advantages.

The density of compound has effect on the required parameters of the compound's hardness and tensile strength, determined above. The optimum range of density from 0.2 to 0.3 g/cm3 is determined experimentally (results are shown in Table 4).

TABLE 4
Dependence of the compound's hardness
and tensile strength on density of compound

| Density of compound, | Compound's hardness on | Tensile strength of the |
|---|---|---|
| g/cm³ | the Shore A Scale | compound, MPa |
| 0.1 | 50 | 4 |
| 0.2 | 55 | 6 |
| 0.3 | 65 | 9 |
| 0.4 | 80 | 13 |

The specified density of the compound is achieved by the technological process of foaming. In particular, the conditions for achieving the density within the range of from 0.2 to 0.3 g/cm3 are compliance with the temperature regimen of the polymer processing with the addition of a foam, which during decomposition is decomposed with gas release.

At the same time, the training of dogs using the disclosed training device showed that when a dog bites down on the body made of EVA based compound with physical and mechanical parameters defined above, a dog receives additional pleasure from biting down on such material, which may be explained by dog's hunting instinct. Such effect makes the device more desirable to a dog during the training.

### DETAILED DESCRIPTION OF THE PREFERRED EMBODIMENT

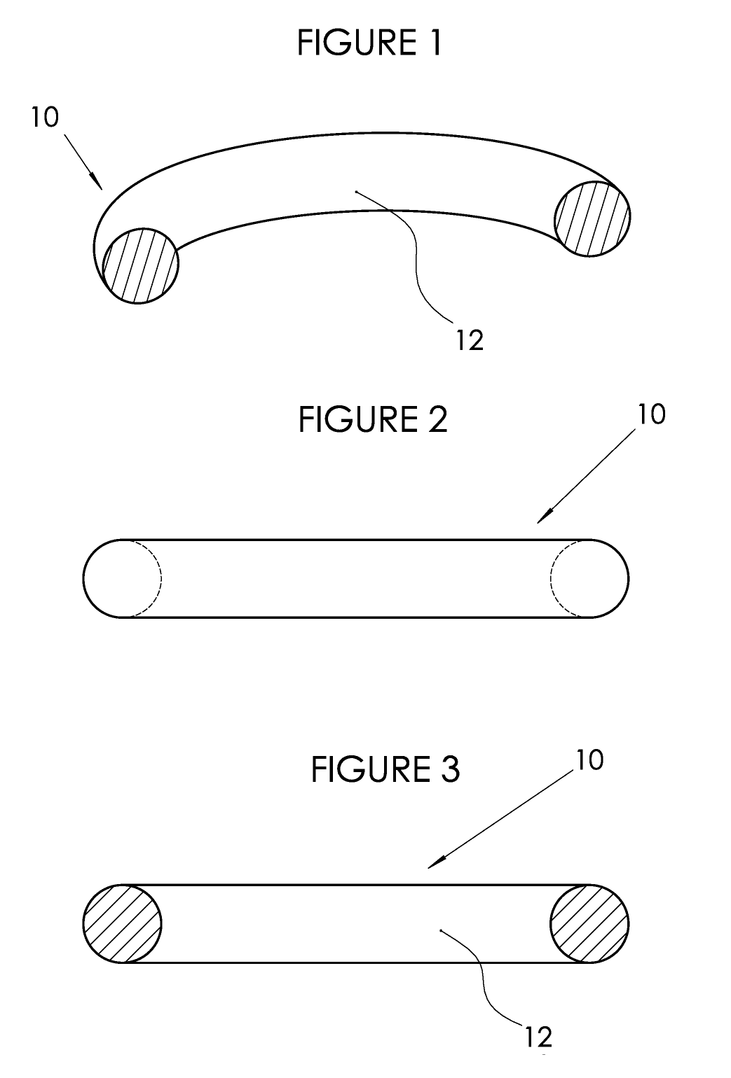

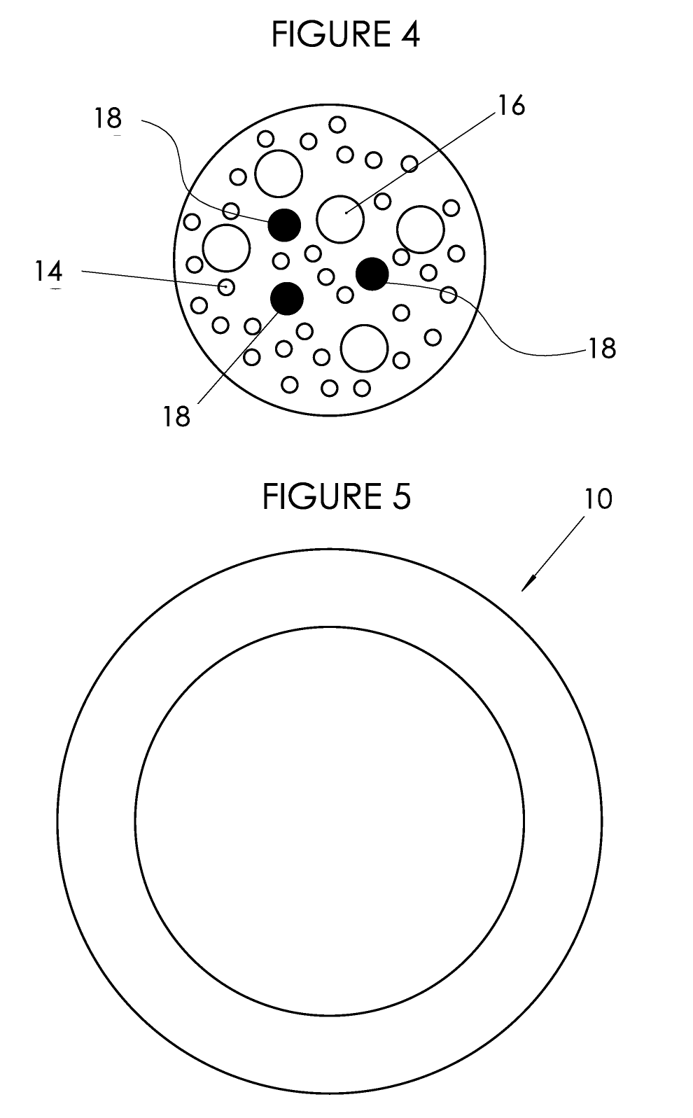

The claimed invention is illustrated by the following exemplary embodiments of a dog training device 10 and the method of making the same. The embodiments of the dog training device are merely exemplary in nature and are in no way intended to limit the claims appended hereto but to explain the essence of the invention. FIG. 1 illustrates a perspective view of a half portion 12 of a device of the present invention generally shown at 10. FIG. 2 illustrates a side view of the device 10. FIG. 3 illustrates a side view of the half portion 12 of the device 10. FIG. 4 illustrates a schematic view of the material that the devices is comprised of wherein each material is shown in its percentage portion. FIG. 5 illustrates a top view of the device 10.

The dog training device 10 includes a ring-shaped body made of a foamed cross-linked compound (the compound) including an ethylene vinyl acetate 14. The compound including a rubber 16 in the amount required to achieve hardness of the compound wherein the hardness based on the Shore A Scale is in the range of 55 to 65 and density of the compound is in the range of 0.2 to 0.3 g/cm3 and tensile strength of the compound is in the range of 6 to 9 MPa, and ultimate elongation of the compound is in the range of 105 to 150%, with the compound also including a non-abrasive filler 18 with particle size ranging between 2 and 5 microns.

### Example 1

The dog training device comprises a body in the form of a ring of circular section as shown in FIG. 5. The material of the body is an EVA based polymeric material, specifically a foamed cross-linked compound containing components in the following ratio, % wt.:

| | |
|---|---|
| Rubber | 30, |
| Non-abrasive filler | 20, |
| Ethylene vinyl acetate | 50. |

In this case, the non-abrasive filler has a particle size of from 3 to 4 microns. Calcite is used as the said non-abrasive filler.

### Example 2

The dog training device 10 comprises a body in the form of a ring of circular section. The material of the body is an EVA based polymeric material, specifically a foamed cross-linked compound containing components in the following ratio, % wt.:

| | |
|---|---|
| Rubber | 50, |
| Non-abrasive filler | 10, |
| Ethylene vinyl acetate | 40. |

In this case, the non-abrasive filler has a particle size of from 2 to 3 microns. Sodium zeolite A is used as the said non-abrasive filler.

### Example 3

The dog training device 10 comprises a body in the form of a ring of circular section. The material of the body is an EVA based polymeric material, specifically a foamed cross-linked compound containing components in the following ratio, % wt.:

| | |
|---|---|
| Rubber | 30, |
| Non-abrasive filler | 20, |
| Odor absorber | 3, |
| Ethylene vinyl acetate | 47. |

In this case, the non-abrasive filler has a particle size of from 4 to 5 microns. Talc is used as the said non-abrasive filler. A natural mineral of volcanic rock, activated charcoal, etc., is used as odor absorber.

### Example 4

The dog training device comprises 10 a body in the form of a ring of circular section. The material of the body is an EVA based polymeric material, specifically a foamed cross-linked compound containing components in the following ratio, % wt.:

| | |
|---|---|
| Rubber | 20, |
| Non-abrasive filler | 20, |
| Odor absorber and deodorant | 5, |
| Ethylene vinyl acetate | 55. |

In this case, the non-abrasive filler has a particle size of 3 microns. Chemically precipitated chalk is used as the said non-abrasive filler. The odor absorber and deodorant can be mixed in the form of a concentrate that is used in making polymeric articles.

The exemplary embodiments of the training device described above are required to achieve the following physical and technical parameters of the compound: hardness on the Shore A Scale in the range of from 55 to 65, compound density in the range of 0.2 . . . 0.3 g/cm3, tensile strength of the compound in the range of from 6 to 9 MPa, ultimate elongation of the compound in the range of from 105 to 150%,

According to one of the embodiments of the invention, the body is preferably ring-shaped, more preferably, has a form of a ring of circular section.

According to the exemplary embodiments described above, the dog training device is made by die injection molding. For this purpose, rubber is pumped into an extruder heated to a temperature of from +92 to 97 degrees Celsius, then a non-abrasive filler and ethylene vinyl acetate, as well as an odor absorber and/or deodorant (according to the second embodiment) e.g. in the form of a superconcentrated powder are added and the compound is then polymerized (its crosslinked) at a temperature of from +175 to 185 degrees Celsius.

The above parameters along with making the article by injection molding in accordance with the given parameters of the method allow to achieve the said technical result, specifically increased reliability, duration, convenience and safety of the use of the dog training device both for a dog and for a human and, at the same time, to make the training device more attractive for biting by a dog, to increase the tensile strength of the body and to significantly simplify the process of making the same. The advantages are achieved only by the combination of the shape of the body and the material of the training device rather than by the complication of the structure of the body or the use of a combination of various physical parameters of materials known in the art.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A dog training device comprising:
a ring-shaped body made of a foamed cross-linked compound including an ethylene vinyl acetate, and
said foamed cross-linked compound including a rubber in the amount required to achieve hardness of said foamed cross-linked compound wherein the hardness based on the Shore A Scale is in the range of 55 to 65 and density of said foamed cross-linked compound is in the range of 0.2 to 0.3 g/cm3 and tensile strength of said foamed cross-linked compound is in the range of 6 to 9 MPa, and ultimate elongation of said foamed cross-linked compound is in the range of 105 to 150%, with said foamed cross-linked compound also including a non-abrasive filler with particle size ranging between 2 and 5 microns.

2. The dog training device as set forth in claim 1, wherein said foamed cross-linked compound includes following components in the following ratio, % wt.: a rubber from 20 to 50, a non-abrasive filler from 10 to 30, an ethylene vinyl acetate being the rest.

3. The dog training device as set forth in claim 2, wherein said foamed cross-linked compound including said components in the following ratio, % wt.: said rubber-30, said non-abrasive filler-20, said ethylene vinyl acetate being the rest.

4. A dog training device made in the form of a preferably ring-shaped body made of a foamed cross-linked compound comprising ethylene vinyl acetate, wherein said foamed cross-linked compound further comprises a rubber in the amount required to achieve hardness said foamed cross-linked compound on the Shore A Scale in the range of from 55 to 65, density in the range of from 0.2 to 0.3 g/cm3, tensile strength in the range of from 6 to 9 MPa and ultimate elongation in the range of from 105 to 150%, said foamed cross-linked compound including a non-abrasive filler with particle size ranging between 2 and 5 microns and an odor absorber and/or deodorant.

5. The dog training device as set forth in claim 4, wherein said foamed cross-linked compound includes said components in the following ratio, % wt.

| | |
|---|---|
| Rubber | from 20 to 50, |
| Non-abrasive filler | from 10 to 30, |
| Odor absorber and/or deodorant | from 2 to 5, |
| Ethylene vinyl acetate | the rest. |

6. The dog training device as set forth in claim 5, wherein said foamed cross-linked compound includes said components in the following ratio, % wt.

| | |
|---|---|
| Rubber | 30, |
| Non-abrasive filler | 20, |
| Odor absorber and/or deodorant | 3, |
| Ethylene vinyl acetate | the rest. |

7. The dog training device as set forth in claim 4, wherein a natural filler is selected from a group including at least one of a calcite, a talc, a sodium zeolite A, a chemically precipitated chalk is used as a non-abrasive filler.

8. The dog training device as set forth in claim 4, wherein a compound obtained by injection molding is used.

9. The dog training device as set forth in claim 1, wherein said ring-shaped has bending resistance ranging between 30,000 and 50,000 bends.
